(19) United States
(12) Patent Application Publication
(10) Pub. No.: US 2008/0120861 A1
(43) Pub. Date: May 29, 2008

(54) APPARATUS AND METHOD FOR COPLANARITY TESTING

(75) Inventors: Jie Ren, Shenzhen (CN); Albert Chiu, Shindian (TW); Wee-Peng Tay, Shindian (TW)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRIAL CO,.LTD., Shenzhen (CN); Sutech Trading Limited, Tortola (VG)

(21) Appl. No.: 11/627,632

(22) Filed: Jan. 26, 2007

(30) Foreign Application Priority Data
Nov. 24, 2006 (CN) 200610157039.X

(51) Int. Cl. G01B 5/25

(52) U.S. Cl. 33/533

(57) ABSTRACT

A testing apparatus (200) for testing coplanarity of workpieces (50) having protuberant structures (53) includes a working plane (21) and a groove (23) defined on the working plane. The groove is configured to movably receive therein all protuberant structures of the workpieces. A testing method employing the testing apparatus to test coplanarity of workpieces having protuberant structures is also provided.

### BACKGROUND OF THE INVENTION

1. Field of the Invention

The present invention relates generally to a coplanarity testing apparatus for testing coplanarity of workpieces, and, more particularly, to a testing apparatus and a testing method of using the same that can simplify procedures of testing coplanarity of workpieces.

2. Description of Related Art

The coplanarity of many workpieces requires testing. At present, coplanarity of a large number of workpieces is mainly tested by means of a testing apparatus and a checking block. A workpiece requiring testing is placed on a working plane of the testing apparatus and in tight contact with the working plane. The checking block is pushed along a side of the workpiece to slide on the working plane. If the workpiece can be pushed to slide on the working plane, or the checking block cannot be inserted between the workpiece and the working plane, the workpiece passes the test. Contrarily, if the checking block can be inserted between the workpiece and the working plane, the workpiece cannot pass the test.

When testing workpieces having protuberant structures, such as locating pins or locating poles, it is necessary to form a containing structures on the testing apparatus for stably placing/positioning the workpieces. Referring to FIG. 1, a typical testing apparatus 100 is a plane plate, including a working plane 11. The working plane 11 has a high coplanarity. A pair of apertures 13 and a groove 15, adjacent to the apertures 13, is defined in the working plane 11.

Also referring to FIG. 2 and FIG. 3, a workpiece 40 is tested by using the testing apparatus 100. The workpiece 40 is a connector and includes a plurality of contacting portions 41, a pair of locating pins 43, a leading portion 45, and a bottom surface 47. Each contacting portion 41 includes a contacting surface 411. All contacting surfaces 411 are coplanar with the bottom surface 47. The testing apparatus 100 is used to test coplanarity of the contacting surfaces 411.

When testing the workpiece, the bottom surface 47 is placed in tight contact with the working plane 11 of the testing apparatus 100. The locating pins 43 are respectively inserted into their corresponding apertures 13. The leading portion 45 is received in the groove 15. In this way, the contacting surface 411 of each contacting portions 41 is also held in tight contact with the working plane 11. Thus, a standard, known checking block can be used to test the coplanarity of the contacting surface 411 of each contacting portion 41.

However, it costs much time to align the locating pins 43 with the apertures 13 and insert locating pins 43 into the apertures 13. If the typical testing apparatus 100 is used to test a large number of workpieces, the testing procedure costs more time. Additionally, the typical testing apparatus 100 can only be used to test workpieces in the same standard with the apertures 13 and the groove 15. If a kind of workpiece includes some protuberant structures of a different standard to the apertures 13 and the groove 15, the typical testing apparatus 100 cannot be used to test this kind of workpiece.

Therefore, a new testing apparatus and a new testing method for testing coplanarity of workpieces are desired in order to overcome the above-described shortcomings.

### SUMMARY OF THE INVENTION

In one aspect, a testing apparatus for testing coplanarity of workpieces having protuberant structures includes a working plane and a groove defined in the working plane. The groove is configured to movably receive therein all protuberant structures of the workpieces.

In another aspect, a testing method for testing coplanarity of workpieces having protuberant structures includes these following steps: providing a testing apparatus, the testing apparatus including a working plane and a groove defined in the working plane, the groove being configured to movably receive therein all protuberant structures of the workpieces; placing a workpiece on the working plane; and receiving the protuberant structures in the groove; and testing coplanarity of the workpieces.

Other advantages and novel features will become more apparent from the following detailed description when taken in conjunction with the accompanying drawings.

### BRIEF DESCRIPTION OF THE DRAWINGS

Many aspects of the present invention can be better understood with reference to the following drawings. The components in the various drawings are not necessarily drawn to scale, the emphasis instead being placed upon clearly illustrating the principles of the present testing apparatus and method. Moreover, in the drawings, like reference numerals designate corresponding parts throughout the diagrams.

FIG. 1 is a schematic view of a typical testing apparatus;

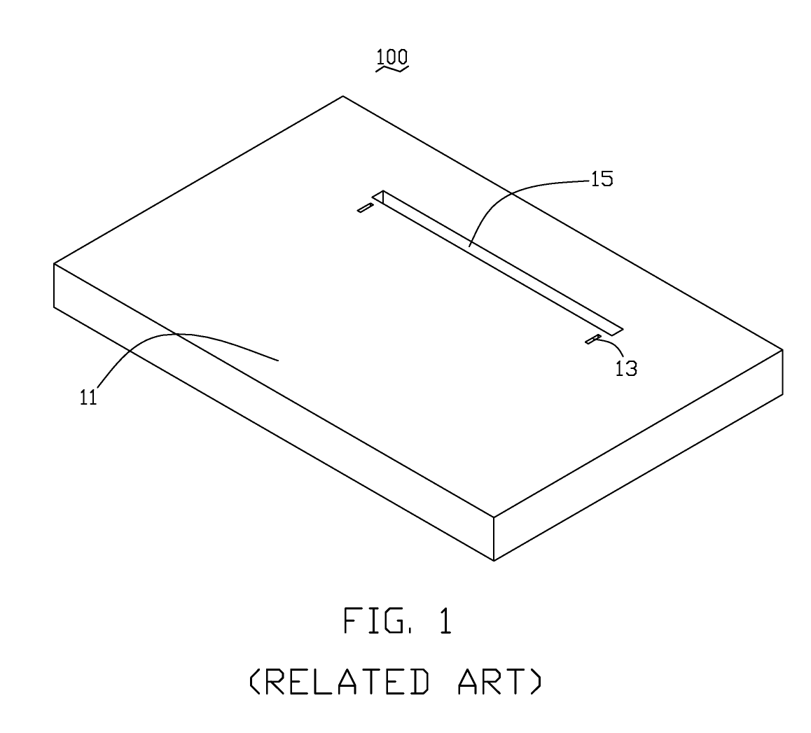

FIG. 2 is a schematic view of a workpiece, requiring testing by the testing apparatus shown in FIG. 1;

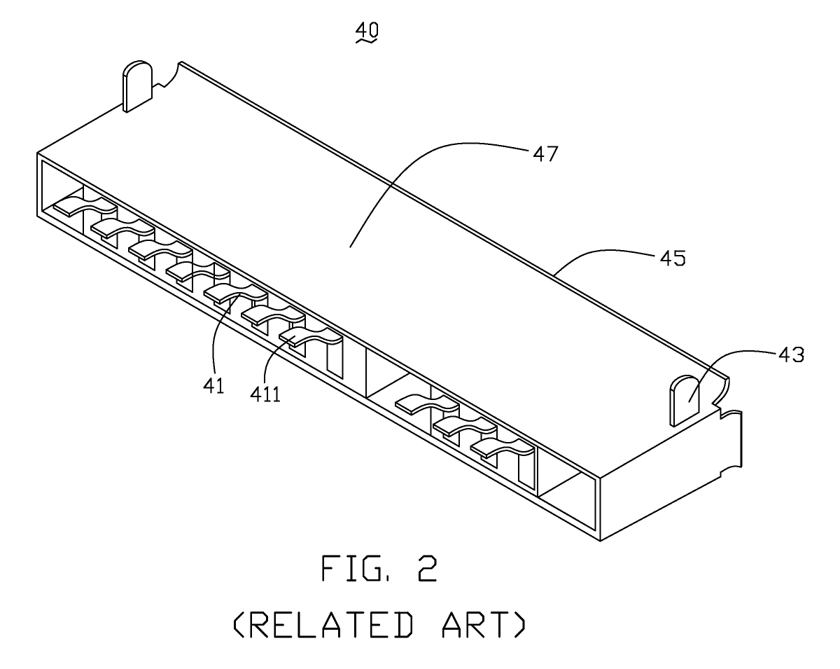

FIG. 3 is a schematic view of the use of the testing apparatus shown in FIG. 1 to test a coplanarity of the workpiece shown in FIG. 2;

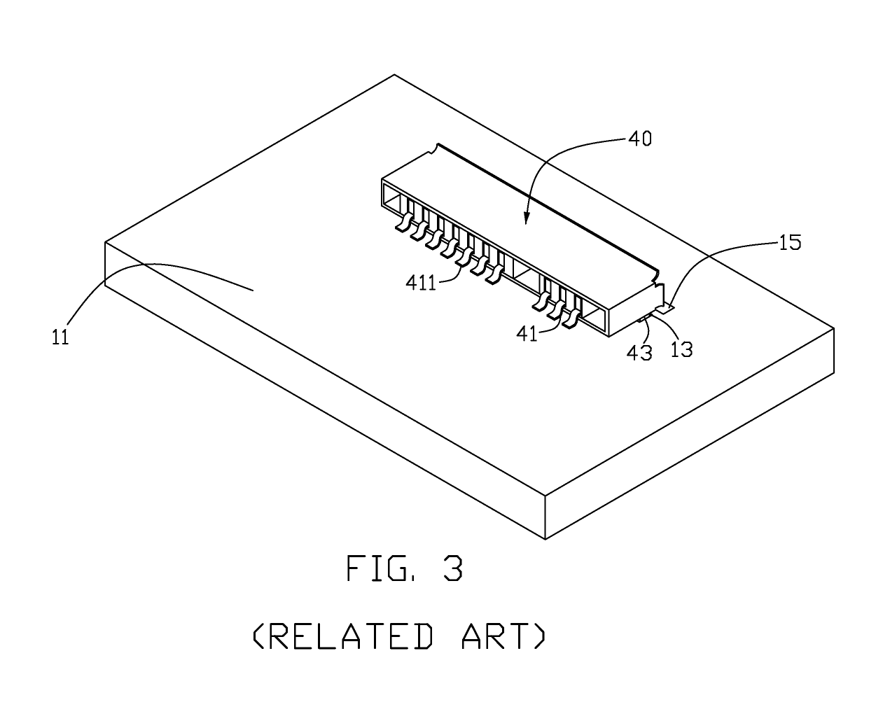

FIG. 4. is a schematic view of a testing apparatus, in accordance with a first preferred embodiment;

FIG. 5 is a schematic view of a workpiece requiring testing by the testing apparatus shown in FIG. 4;

FIG. 6 is a schematic view of the use of the testing apparatus shown in FIG. 4 to test the coplanarity of the workpiece shown in FIG. 5;

FIG. 7 is a schematic view of a testing apparatus, in accordance with a second preferred embodiment; and

FIG. 8 is a schematic view of the use of the testing apparatus shown in FIG. 7 to test the workpiece shown in FIG. 5.

### DETAILED DESCRIPTION OF THE INVENTION

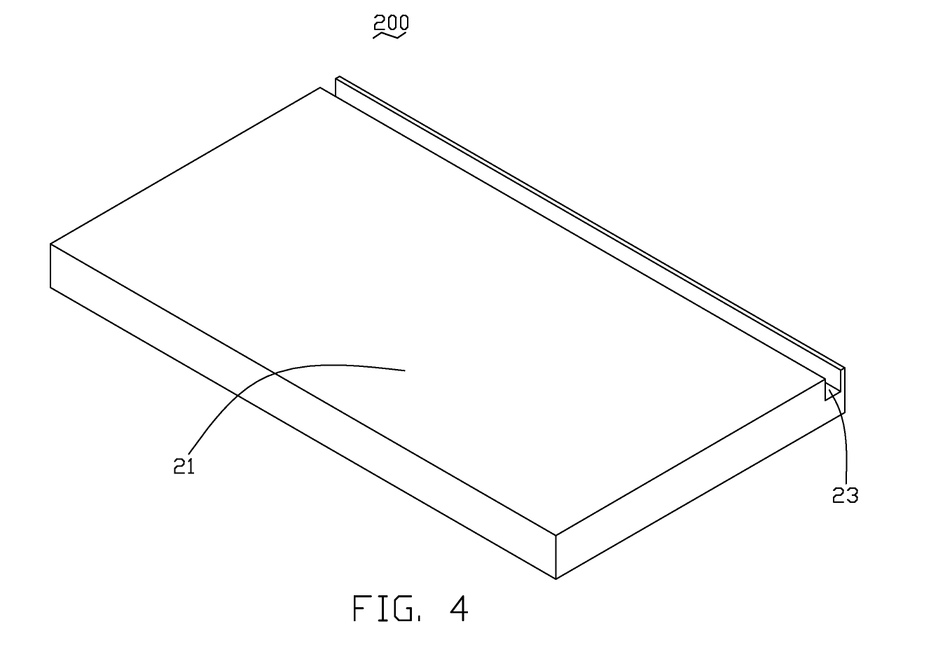

Referring now to the drawings in detail, FIG. 4 shows a testing apparatus 200, in accordance with a first preferred embodiment. The testing apparatus 200 is used to test coplanarity of workpieces having protuberant structures, such as connectors.

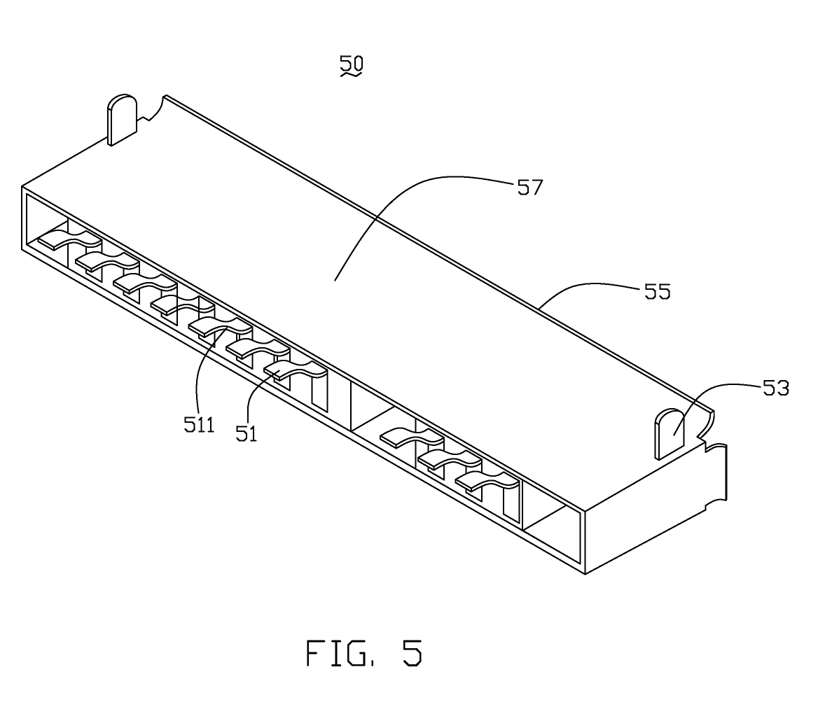

Also referring to FIG. 5, a workpiece 50 requiring testing by the testing apparatus 200 is provided. The workpiece 50 is a connector including a plurality of contacting portions 51, a pair of protrusions 53, a leading portion 55, and a bottom surface 57. Each contacting portion 51 includes a contacting surface 511 configured (i.e., structured and arranged) for contacting with circuit components to conduct electricity. The protrusions 53 can be, e.g., through-hole connectors, locating pins, locating poles, etc. The leading portion 55 is an extending portion formed along a side of the workpiece 50 to lead/guide the workpieces to places where the workpiece 50 can be mounted. All contacting surfaces 511 are coplanar with the bottom surface 57, and coplanarity of the contacting surfaces 511 with the bottom surface 57 and with one another require testing.

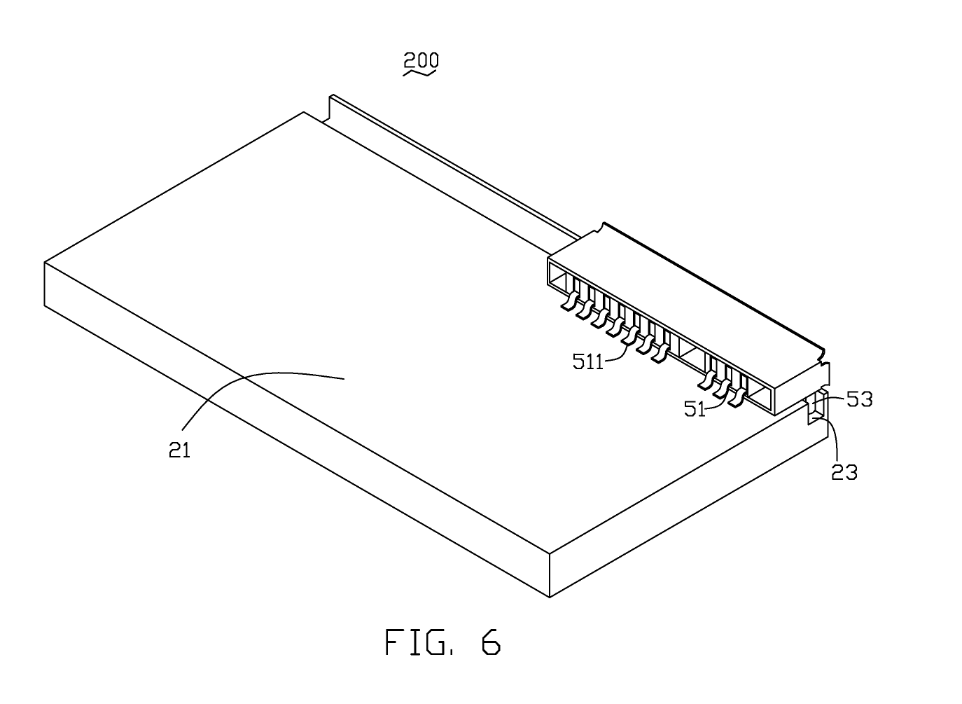

Also referring to FIG. 6, the testing apparatus 200 is a plate beneficially made of a hard and wear-resistant material, such as SKD11 steel. The testing apparatus 200 includes a working plane 21. The working plane 21 has a high coplanarity, and the coplanarity of the working plane 21 is at least one precision level higher than that required of the contacting surfaces 511. A groove 23 is defined in the working plane 21, and the groove 23 is defined adjacent to and extending along a side of the testing apparatus 200. Depth and width of the groove 23 are respectively approximately equal to or greater than the corresponding depth and width of the protrusions 53 of the workpiece 50. The length of the groove 23 is large enough for the protrusions 53 to be able to be movably received in the groove 23.

A method of testing coplanarity of the contacting surfaces 511 of the workpiece 50 by using the testing apparatus 200 includes these following steps:

providing a testing apparatus 200;
placing a workpiece 50 on the working plane 21 of the testing apparatus 200, the protrusions 53 being received in the groove 23, the leading portion 55 being placed out of the working plane 21, and the contacting surfaces 511 of the contacting portions 51 being held in tight contact with the working plane 21; and
using a checking block (not shown) to test coplanarity of the contacting surfaces 511 by means of typical/standard procedures.

Understandably, the testing apparatus 200 can also be used to test workpieces without any protrusion. The testing apparatus 200 can also be used to test workpieces having other kinds of protuberant structures, so long as all protuberant structures of these workpieces can be received in the groove 23.

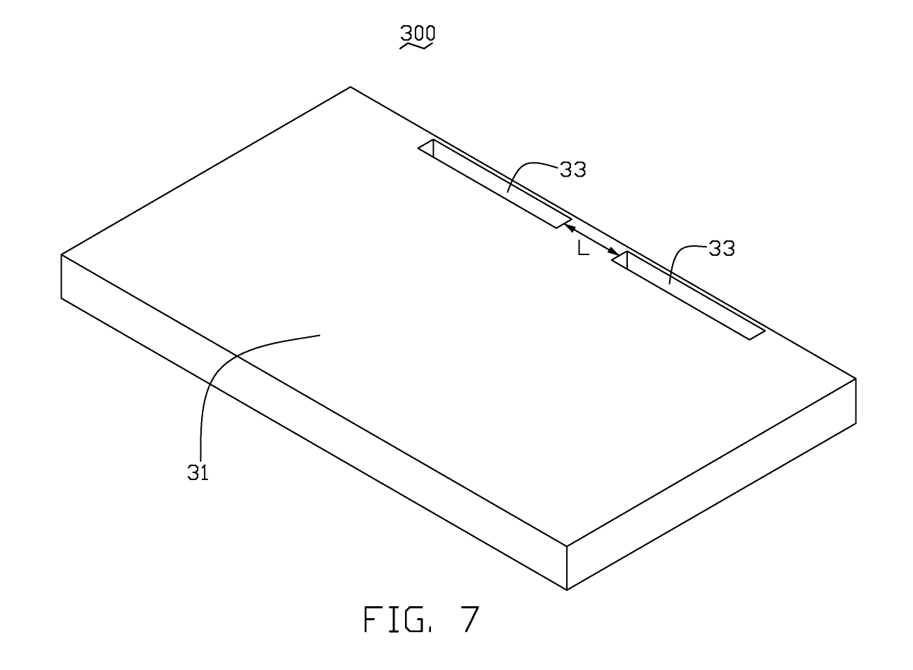

Referring to FIG. 7, a testing apparatus 300 in accordance with a second preferred embodiment, is shown. The testing apparatus 300 is also used to test coplanarity of workpieces having protuberant structures, such as the workpiece 50.

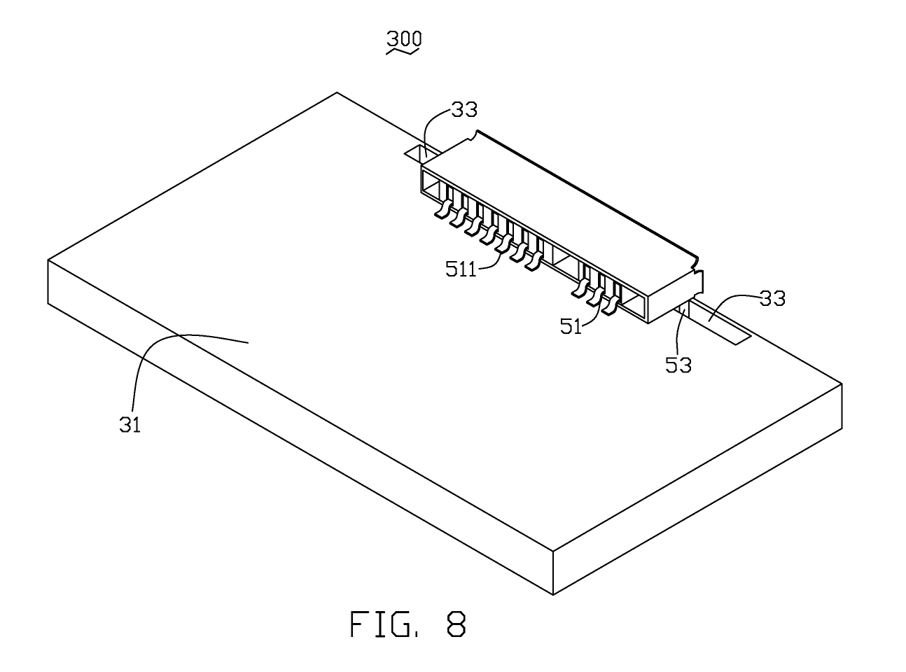

Also referring to FIG. 8, similar to the testing apparatus 200, the testing apparatus 300 is a plate made of a durable material, such as steel. The testing apparatus 300 includes a working plane 31, and the working plane 21 has a high coplanarity that is at least one precision level higher than that required of the contacting surfaces 511. A pair of grooves 33 is defined in the working plane 31, and the grooves 33 are defined adjacent to and extending along a side of the testing apparatus 300. The grooves 33 are located colinearly, and there is a distance L between two adjacent ends of the grooves 33. Depth and width of the grooves 33 are respectively approximately equal to or larger than the corresponding depth and width of the protrusions 53 of the workpiece 50. The length of each groove 33 is large enough for a protrusion 53 to move therein, and the distance L is less than a distance between the two protrusions 53. Therefore, each protrusion 53 can be movably received in its respective groove 33.

A testing method of using the testing apparatus 300 to test a coplanarity of the contacting surfaces 511 of the workpiece 50 includes these following steps:

providing a testing apparatus 300;
placing a workpiece 50 on the working plane 31 of the testing apparatus 300, each protrusion 53 being received in its respective groove 33, the leading portion 55 being placed out of the working plane 31, and the contacting surfaces 511 of the contacting portions 51 being in tight contact with the working plane 31;
using a checking block (not shown) to test the coplanarity of the contacting surfaces 511 by means of typical/standard procedures.

Understandably, the testing apparatus 300 can also be used to test workpieces without any protrusion. The testing apparatus 300 can also be used to test workpieces having other kinds of protuberant structures if all protuberant structures of these workpieces can be movably received in the grooves 33. Additionally, more grooves 33 can be defined on the working plane 31. Distances between the grooves 33 must be less than that between the protuberant structures 53 so that the protuberant structures can be movably received in the particular grooves 33.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A testing apparatus for testing coplanarity of workpieces having protuberant structures, comprising:
a working plane; and
a groove defined in the working plane, the groove being configured to movably receive therein all protuberant structures of the workpieces.

2. The testing apparatus as claimed in claim 1, wherein the testing apparatus is a plate made of a hard material.

3. The testing apparatus as claimed in claim 1, wherein coplanarity of the working plane is at least one precision level higher than that required for the portions of the workpiece being tested.

4. The testing apparatus as claimed in claim 1, wherein the groove is defined adjacent to a side of the testing apparatus.

5. The testing apparatus as claimed in claim 1, wherein the depth and width of the groove are respectively approximately equal to or larger than a corresponding depth and width of the protrusion structures of the workpiece.

6. A testing apparatus for testing coplanarity of workpieces having protuberant structures, comprising:
a working plane; and
a plurality of grooves defined in the working plane and located in alignment with each other, the grooves being configured for movably receiving therein a respective protuberant structure of the workpiece.

7. The testing apparatus as claimed in claim 6, wherein the testing apparatus is a plate made of hard material.

8. The testing apparatus as claimed in claim 6, wherein a coplanarity of the working plane is at least one precision level higher than that required for the workpiece being tested.

9. The testing apparatus as claimed in claim 6, wherein the grooves are defined adjacent to a side of the testing apparatus.

10. The testing apparatus as claimed in claim 6, wherein the depth and width of the grooves are respectively approximately equal to or larger than a corresponding depth and width of the protrusion structures of the workpiece.

11. The testing apparatus as claimed in claim 6, wherein each groove respectively movably receives a protuberant structure of the workpiece.

12. The testing apparatus as claimed in claim 6, wherein distances between the grooves are less than that between the protuberant structures of the workpiece.

13. A testing method for a testing coplanarity of workpieces having protuberant structures, comprising the following steps:
providing a testing apparatus, the testing apparatus including a working plane and a groove defined in the working plane, the groove being configured to movably receive therein all protuberant structures of the workpieces;
placing a workpiece on the working plane and receiving the protuberant structures in the groove; and
testing the coplanarity of the workpieces.

14. The testing method as claimed in claim 13, wherein the coplanarity of the working plane is at least one precision level higher than that required for the workpiece being tested.

15. The testing method as claimed in claim 13, wherein the groove is defined adjacent to a side of the testing apparatus.

16. The testing method as claimed in claim 13, wherein the depth and width of the groove is respectively approximately equal to or larger than a corresponding depth and width of the protrusion structures of the workpiece.

17. The testing method as claimed in claim 13, wherein the testing apparatus includes a plurality of grooves defined on the working plane.

18. The testing method as claimed in claim 17, wherein each groove respectively movably receives a protuberant structure of the workpiece.

19. The testing method as claimed in claim 17, wherein distances between the grooves are less than that between the protuberant structures of the workpiece.
